(19) United States
(12) Patent Application Publication
(10) Pub. No.: US 2008/0120029 A1
(43) Pub. Date: May 22, 2008

(54) Wearable tactile navigation system

(76) Inventors: John S. Zelek, Stratford (CA); Marc Holbein, Guelph (CA)

Correspondence Address: Dr. John S. Zelek, 145 Water St., Stratford, ON, N5A 3C3, omitted

(21) Appl. No.: 11/707,031

(22) Filed: Feb. 16, 2007

Related U.S. Application Data
(60) Provisional application No. 60/773,642, filed on Feb. 16, 2006.

(51) Int. Cl. G01C 21/00

(52) U.S. Cl. 701/213

(57) ABSTRACT

The wearable tactile navigation system frees you from requiring to use your eyes as there is no display, all positional information is conveyed via touch. As a compass, the device nudges you towards North. As a GPS navigator, the device orients you towards a landmark (i.e., home) and lets you feel how far away home is. A bluetooth interface provides network capabilities, allowing you to download map landmarks from a cell phone. The bidirectional networking capability generalizes the device to a platform capable of collecting any sensor data as well as providing tactile messages and touch telepresence. The main application of the device is a wayfinding device for people that are blind and for people that suffer from Alzheimer's disease but there are many other applications where it is desirable to provide geographical information in tactile form as opposed to providing it in visual or auditory form.

### FIELD OF THE INVENTION

The invention relates to navigation systems and specifically to an improved that provides directional and distal information about user position and environment object position and orientation to a user only in tactile form. The device is a wearable tactile navigation system. In one role, the device is a wearable compass, worn as a belt around the waist. The device can either use a compass for its bearing or a gps unit, both embedded. A haptic (tactile) belt produces orientation information by vibrating at a particular angle of the belt, indicating magnetic north. The device is to be used as a homing device for people who are blind, who suffer from Alzheimer's, as well as having other commercial uses, such as for hikers and sailors. The entire system also has a GPS and can provide distance information as well as orientation to user defined beacon positions (home). The device can be referred to as a sensory substitution device. The design is innovative in that it capitalizes on the ability of the human tactile system to interpolate between stimulation points. One market is for people who are blind or visually impaired. A person who is blind relies on either a long white cane or guide dog to navigate the world. They are not able to use a conventional compass and cannot locate landmarks unless they can touch them with their long cane. Our device's role is not to replace but rather to augment the use of existing aids. The device provides an orientation and mobility functionality that augments, is non-obtrusive, intuitive, inexpensive, and able to interface with other technology such as a cell phone or i-pod.

Our world is very visual, for example, traffic signs provide direction to only those that can see them. Landmarks (natural or man made) provide direction and help us orient ourselves in the world. The earth's inherent magnetic field provides 2 natural landmarks, the North and South poles. The GPS (Global Positioning System) is a network of satellites that permits a receiver to calculate the precise time and its current position (latitude, longitude, elevation) using trilateration. The human tactile system is typically under utilized for user interfaces and is a natural choice for orientation aids for people who are blind. People who are blind rely heavily on their auditory senses to make sense of the world's ongoings, especially in an urban environment. We have chosen the waist to convey directional information via a belt instantiation (360 degrees around the waist corresponds to potential compass settings). We can alternatively choose any piece of clothing that hugs the body provided that a natural frame of reference orientation system is available. The display of a compass has always been visual, whether in analogue or digital form. Alternatively, we suggest using the human body as an interface to feel magnetic North or a home waypoint. As one instantiation, we make use of the body's inherent frame of reference, correlating the notion of front and back with the poles. A haptic (touch) belt indicates direction by vibrating in the direction of the North pole. In addition, GPS is used to provide an alternative landmark to the North pole. We use only 4 motors and make use of the human perceptual system to interpolate to provide a continuum of potential readings at a resolution only limited by the perceptual system. The device is unique in that it incorporates innovative technology for producing the continuum of directional values using only 4 motors and the device is also affordable, provides independence and improves quality of life, simple and intuitive to use and has other potential verticals in the consumer market, applications including mariner wayfinding, hiking, search and rescue and possibly tourism.

### BACKGROUND OF THE INVENTION

Physiology:

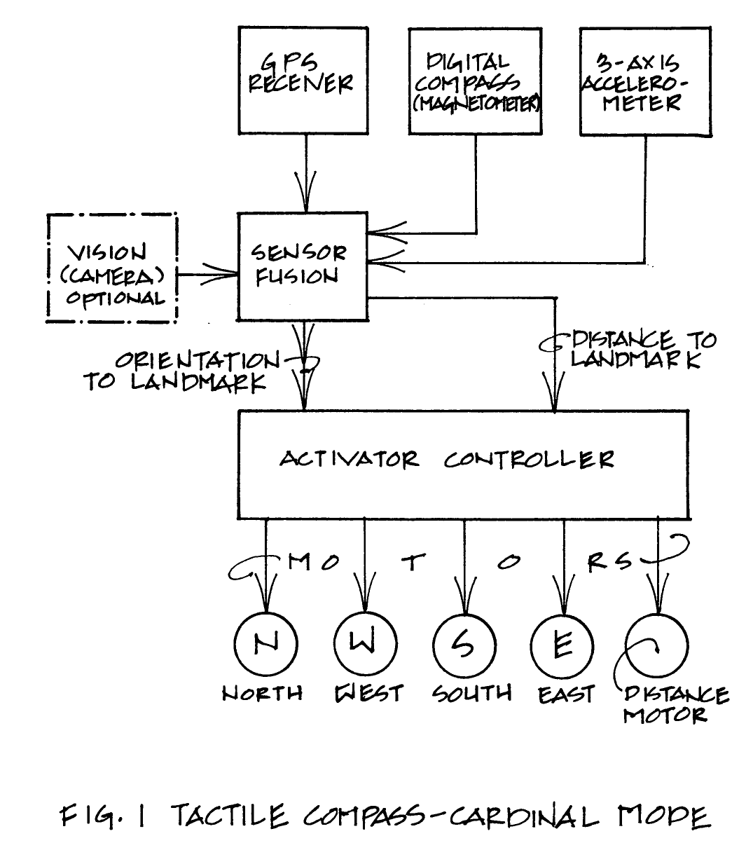

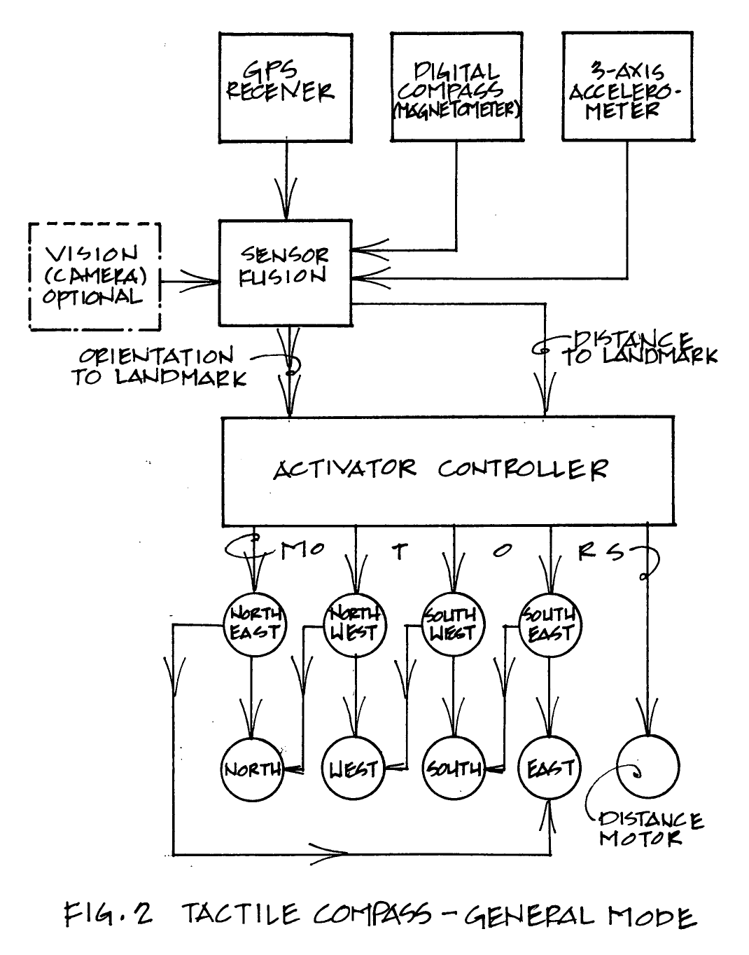

Local properties of mechano-receptors are understood but not their collective interactions. The modelling of a single mechano-receptor (including the mechanics of the skin, end organ, creation of a generator potential, the initiation of the action potential and branching of afferent fibres) has recently been studied for single collections in the fingertips [Pawluk, 1997]. This work requires further development into the population responses of neighbourhoods with both excitatory and inhibitory activity. Empirical investigations have provided us with rough estimations on the sizes of the excitatory portion of the receptive fields for touch on the hand. The receptive field distributions are not unlike the fovea-periphery distinction for visual perception where the touch receptors in the fingertips correspond to the fovea (see FIG. 1). As expected, training also influences the number and size of the receptive fields, i.e., the sensitivity of the hand improves (see FIG. 2). However, we are not interested in analyzing the fingertip touch receptors.

The tactile unit consists of the primary afferent neurons whose sensors endings respond

to light skin deformations and are chiefly located in the dermis (note that other afferent units for joint and muscle receptors may have tactile roles) [Vallbo and Johansson, 1984]. The number of tactile units in one hand number roughly 17,000, supplying the glaborous (non-hairy) skin area. There are two types of tactile fibres Aα (tactile fibres, larger) and Aδ (nociceptive and thermo-sensitive units, smaller). There are basically four types of tactile units, differing by functional properties such as sensitivity to static and dynamic events, size and structure of receptive fields, the numbers, densities and perceptive effects. The four afferent fibre types (PC (Pacinian Corpuscles) or RAII, RAI, SAII and SAI) are the four basic types. The SAI system plays a primary role in tactual form and roughness perception when the fingers contact a surface directly and for the perception of external events through force distribution across the skin surface. The PC system reacts to the high frequency vibration. The RA system is responsible for the detection and representation of localized movement between skin and a surface. Age reduces the sensitivity, for example, the fingertips of pre-teen individuals contains forty to fifty Meissner corpuslces (NPI, RAI) per square millimeter, whereas by age 50 this has dropped to ten per square millimeter [Sekuler and Blake, 2002]. It was found that intensity JND ((just noticeable discrimination) (measured as 20 log

$$20 log \frac{A + Δ A}{A} ,$$

where A is vibration amplitude and AA is the amplitude increment) decrease as intensity increases and are roughly independent of frequency and range between 0.4 and 3.5 dB [Tan, 1996]. It is not so clear with regards to frequency discrimination, as frequency JND varies with intensity. Even when intensity cues are removed, the results are not conclusive, but roughly, frequency/pitch JNDs increase with frequency over a range of 5 to 512 Hz [Tan, 1996]. With regards to temporal resolution, JNDs increase monotonically from 50 to 150 msec when duration increased from 0.1 to 2.0 seconds. Some experiments have indicated that the time difference between non-fused perception is roughly 10-15 msec, thus providing a rough estimate of a bandwidth that can be conveyed. Explorations on the necessary spatial resolution for duplicating tactile feeling hypothesizes that placing actuators at one half the TPDT (two-point discrimination threshold) is sufficient provided that stimulus presentation to the four types of mechano-receptors is controlled individually [Asamura et al., 2001].

To summarize, there are four mechanoreceptor populations in the glaborous skin of the human hand with FA referring to fast adapting, SA referring to slow adapting, and I and II being the index in each category [Klatzky and S. J. Lederman, 2002]. The receptive field of index I is small and well defined and the receptive field of index II is large and diffuse. The FA mechanoreceptors are fast with no response to sustained stimulation. The SA mechanoreceptors are slow and respond to sustained stimulation. A more detailed and recent characterization of the cutaneous mechanoreceptors is provided by [Gescheider et al., 2004]. There are factors that influence the response of the mechanoreceptors including attention and aging [Craig and Rollman, 1999]. There is also adaptation, in particular, to the disappearance of the sensation of pressure when coincided with an almost constant value of velocity of indentation [Sherrick and Cholewiak, 1986]. There is also some adaptation to vibrotactile stimulation but at a much slower scale. As shown later in the paper, PWM in essence produces amplitude modulation in the applied mechanical signal. The sensitivity to an amplitude modulated vibrotactile stimulus is governed by the tactile temporal threshold which varies from 10 to 50 ms [Weisenberger, 1986]. Thus, in the best case scenario, amplitude modulation can be implemented up to 100 Hz.

Cutaneous Saltation: Rabbit Effect:

Our perception of sensory stimulation can be biased by the arrival of subsequent events. One such illusion or effect is referred to as cutaneous saltation or the rabbit effect. If a sequence of taps is performed at a regular sample at 3 different locations, lets say with 4 or 5 taps at each spatial location, what is perceived are not 4 or 5 taps at the locations where the force was applied, but rather a uniform distribution of taps is experienced. This refers to the human perceptual system being able to interpolate [Eimer et al., 2005] between impulse locations. In this application, we make use of this phenomenon to present a continuum of information across the body while only stimulating a finite amount of locations.

Vibrotactile Communication:

A vibratory communication system (called Vibratese) was developed in the fifties [Geldard, 1957], where five calibrated vibrators placed on the chest, each varied in three intensity levels (20 to 400 μm) and three durations (0.1, 0.3 and 0.5 sec) at a fixed frequency of vibration of 60 Hz represented a 45 element system consisting of the single letters and digits. Subjects could learn the code in about 12 hours and be able to receive 38 words per minute (a word being five-letters) [Tan, 1996].

Vibrotactile communication in the field of tactile aids for the hearing impaired has a rich history [Summers, 1992]. The devices are used in conjunction with or without a hearing aid and are used to help decipher speech and ambient environmental sounds (e.g., street traffic). The devices use one or more tactors resonating at a fixed frequency, preserving amplitude intensity. Tactors are usually assigned to different parts of the spectrum in terms of the input signal. The Tactaid VII system translates microphone captured audio into a harness with 7 resonant vibrators to be worn on either the forearm, chest, abdomen or neck. A historical review of tactual displays for sensory substitution provided by [Tan and Pentland, 2001] illustrates two major types: (1) pictorial or (2) frequency in place. The Optacon was a finger pin-based system for discriminating quantized tactile representations of text while the Optohapt consisted of 9 vibrators encoding letters of the alphabet. Another sensory substitution device includes the TVSS, a 20 by 20 matrix of solenoid vibrators mounted on a dental chair back conveying camera information.

Vibrotactile displays on parts of the body have been already used to demonstrate a wide range of cognitive augmenting functions for the purpose of improving situational awareness and navigation [Tan and Pentland, 2001], [Tan et al., 2003], balance [Wall et al., 2001], for visualizing medical data [Weissgerber et al., 2004], blind navigational aid [Zelek, 2004] and a 3D spatial orientation awareness [Rupert, 2000]. Vibrotactile displays have been placed on the shoulder [Toney et al., 2003], chest as a vest [Jones et al., 2004], hand as a glove [Zelek, 2004], and waist and chest and other parts of the body including arms and legs [Rupert, 2000], in addition to placing tactile arrays on furniture (i.e., chair) that the body makes contact with [Tan et al., 2003].

Attempts to engage both the tactile and kinesthetic senses [Tan and Pentland, 2001] include the “reverse-typewriter” system, OMAR system, the MIT Morse code display and the Tactuator. The Tactuator consisted of 3 independent, point-contact, one degree-of-freedom actuators interfaced individually with the fingertips of the thumb, index and middle finger providing gross motion to stimulate the kinesthetic and vibrations in the range of 0 to above 300 Hz. Although ideal, these are laboratory instruments and do not lend themselves to wearable and portable implementations.

Tactors:

There are many possible technologies for producing vibrotactile cues—these devices are referred to as tactors—including solenoids (pin arrays), voice coils (speakers), arm linkages and electromagnetic motors (pager motors).

Solenoids are found in the construction of Braille displays [Toney et al., 2003]. Their maximum firing frequency is limited by the mechanical travel of the solenoid slug. To function properly, they rely on a small sharp contact surface with a high degree of contrast. In addition, their power requirements are high. Another alternative is to use mini speakers and some researchers have found them to be effective for vibrotactile stimulation [Murray et al., 2003], [Toney et al., 2003]. One drawback is the audible noise produced as a result of their function. Piezoelectric stimulators have been demonstrated in wearable applications but their required mounting topology and safety issues as a result of their high operational voltages limit their potential use. Electromechanical vibrators such as ones manufactured by Engineering Acoustics (www.eaiinfo.com) have a relatively broad frequency range (200 to 300 Hz) and large intensity range but are somewhat expensive ($250 US) and require significant power, requiring a 1 W (2 V RMS, 0.5 A RMS) driver. Inexpensive DC motors that produce vibration by rotating an eccentric mass [Lindeman and Cutler, 2003], [Toney et al., 2003] are attractive because they deliver significant vibrational force at low voltages in a small robust package and are inexpensive ($1 to $2 US). However, their vibration frequency and intensity are inherently linked. Two types of designs are (1) cylindrical motors which are miniature DC brush motors with a cam shaped counterweight and (2) pancake motors, which encase an eccentric rotor that has some flexibility on its axis of rotation. The pancake motors provide a more radially uniform distribution of vibrational energy whereas the cylindrical motors distribute most of their mechanical energy along the central axis of their cylindrical body [Toney et al., 2003].

One of the motors we have used [Zelek and Holbein, 2005] was a Sanko pager motor (available from Jameco)—standard operating voltage is 3.0 V, the operating voltage range is 2.5 to 3.8 V, and the standard current draw is 45 mA, with the starting current being 50 mA and the minimum starting voltage being approximately 2.0 V. The Sanko motor weights approximately 1.63 g. It spins at approximately 4500 revolutions per minute (75 revolutions per second).

The other motor used was a waterproof encased cylindrical motor, model 6CL-5472A from Vibrator Motor (vibratormotor.com). Its rated voltage is 1.3 V, operating voltage is 1.1 to 1.6 V, rated current is 75 mA and the starting voltage is 0.7 V. The cylindrical motor weighs 2.99 g and its rated speed is 7500 revolutions per minute (125 revolutions per second).

Our Device

Our device can be labeled as a wearable tactile compass, worn as a belt around the waist. The device can either use a compass for its bearing or a GPS unit, both embedded. A haptic belt produces orientation information by vibrating at a particular angle of the belt, indicating magnetic north. The device is to be used as a horning device for people who are blind as well as having other commercial uses, such as for hikers and sailors. The entire system also has a GPS and can provide distance information as well as orientation to user defined beacon positions (home). The device is a proof of concept demonstrating sensory substitution. The design is innovative in that it capitalizes on the ability of the human tactile system to interpolate between stimulation points. Initial results have been promising. The main market is for people who are blind or visually impaired. A person who is blind relies on either a long white cane or guide dog to navigate the world. They are not able to use a conventional compass and cannot locate landmarks unless they can touch them with their long cane. Our device's role is not to replace but rather to augment the use of existing aids. The initial objectives were to provide an orientation and mobility device that augments, is non-obtrusive, intuitive, inexpensive, and able to interface with other technology such as a cell phone or i-pod.

Currently, our prototype and device uses pager motors that are typically used in cell phones but further advances in wearable haptics for tactile communications as well as force and texture replication will increase the bandwidth of the information that can be conveyed by the device described in this application. The increase of bandwidth is not necessary for directional information but will possibly help in the interpolation of direction between two activated actuators on the belt. However, the increase of bandwidth will help in conveying other information such as obstacles, terrain and distal information to landmarks and targets.

Also, we anticipate using a camera as part of the suite of sensors. Computer vision techniques to detect and label objects in the environment, detect context and localize and map simultaneously will further enrich the suite of environmental and positional information that can be conveyed.

The device proposed (and which has already been prototyped, providing a proof of concept) is a complete system that is wearable and self contained in terms of computational capability and power needs. In addition, one way that we achieve connectivity with external devices and the internet is using technology such as Bluetooth.

### CROSS-REFERENCE TO RELATED APPLICATIONS

Application 60,661,478 entitled “A FPGA Haptics Controller for Controlling Stimulus Parameters of Vibrotactile Tactors in Unconventional modes to produce sustained single and arrays of forces ad other effects in wearable material” is an invention put forward by the same principles as this application. This cross-referenced application pertains to a method of controlling inexpensive vibrating DC (Direct Current) motors (e.g, pager, vibro-tactile motors) so as to increase their bandwidth of information provided.

### DESCRIPTION OF PRIOR ART

Heretofore, navigation devices have used GPS (6671618, 6791477, 6502032, 6838998, 7068163,) or compass (6671618, 6320496), have included tactile interfaces (6671618, 6693622). None of the devices previously identified as prior art have specified the unique method we have outlined here for providing the potential of a continuum tactile identification of all possible directions, integrated with the location/position and environment sensing for navigation purposes in a portable, wearable embodiment and have specified a connectivity of the system to the internet.

A few patents mention the use of haptics, sensory substitution, etc., namely:

1. U.S. Pat. No. 6,791,471 - - - (2004)
This application is entitled Communicating position interface between vehicles.
   “Wireless communication between vehicles may permit position information about one vehicle to be communicated directly to another vehicle. Such an information exchange between vehicles may increase the awareness of an operator of a vehicle to other vehicles in the surrounding environment and may help a vehicle operator operate the vehicle more safely. Vehicles may share through the use of wireless communications position, direction, speed, or other information, such as the deployment of safety devices or the presence of particular types of vehicles (e.g., an emergency vehicle or school bus). The vehicle that receives a wireless communication compares the position, direction, and speed of incoming information from another vehicle to the vehicle's own speed, direction, and position to determine whether action is required.”

2. U.S. Pat. No. 6,671,618 - - - (2002)
This application is entitled Navigation System.
   “A navigation system comprises at least one tactile actuator. The tactile actuator is adapted to provide tactile navigation stimulus for the user of the system. A controller is provided for controlling the operation of the at least one tactile actuator based on information associated with the position of the user. In operation the position of the user and the direction to which the user should move are determined. The user is then guided by means of the tactile navigation stimulus. The navigation system may be implemented as a portable navigator apparatus that comprises at least one tactile actuator and a controller. The portable navigation apparatus may also comprise means for determining information associated with the position of the user.”

3. U.S. Pat. No. 6,486,784 - - - (2002)
This application is entitled Process and system enabling the blind or partially sighted to find their bearings and their way in an unknown environment.
   “The invention concerns a method and a system enabling the blind and the partially sighted to direct themselves and find their way in unknown surroundings. Said method consists in teletraining using a portable sensor in particular touch-sensitive or audio, the blind or partially sighted person about the path he must follow to move from one point to another, avoiding obstacles. Said method enables the blind or partially sighted person, having no material landmark which he could remember and recognize by feeling his way with his walking stick, to find his way particularly in streets of a town, in the corridors of an underground railway or of a building.”

4. U.S. Pat. No. 6,791,477 - - - (2004)
This application is entitled Method and apparatus for identifying waypoints and providing keyless remote.
   “A locator device includes a pocket-sized casing that contains a keyless remote entry circuit for remotely operating a vehicle security system. A GPS receiver circuit is located in the casing and automatically identifies a vehicle waypoint whenever the vehicle is turned off. The locator device then determines from any current location and with a single button press the direction and/or distance back to the vehicle waypoint. Many other novel applications are also performed by the locator device.”

5. U.S. Pat. No. 6,502,032 - - - (200)
This application is entitled GPS urban navigation for the blind.
   “A global positioning system that actively guides blind pedestrians and military/police forces. This system uses DoD Global Positioning System (GPS) to provide user position and navigation to centimeter accuracy. Present position and navigation requests are digitally cellular telephoned to a central “base station” where data is correlated with a computerized map database which holds names and coordinates of specific locations, such as streets; intersections; traffic lights; hospitals; bathrooms; public telephones; and internal layouts of major buildings and facilities, in selected regions, cities, and neighborhoods. System operates by user entering desired destination into hand-held unit via voice recognition software or using Braille keyboard. Hand-held unit then transmits present position (PP) GPS satellite signals and desired destination to a base station which contains map database and surveyor quality GPS computer system.”

6. U.S. Pat. No. 6,774,788 - - - (2004)
This application is entitled Navigation Device for the visually impaired.
   “A handheld navigation device for use by the visually impaired having a camera electrically connected to a microprocessor. The microprocessor is capable of object and character recognition and translation into Braille. A Braille display is electrically connected to the microprocessor. A speaker is electrically connected to the microprocessor for audibly communicating common objects and distances and character recognition translations to the user.”

7. U.S. Pat. No. 6,320,496 - - - (2001)
This application is entitled Systems and methods providing tactile guidance using sensory supplementation.
   “A tactile guidance system and method provides a user with navigational assistance through continuous background communication. This continuous background communication is realized through tactile cueing. By making the direction giving through tactile cues, a user's main attention can focus on visual and auditory cues in the real world, instead of focusing on the direction giving device itself. An electronic compass maintains the orientation of a user. A navigation state is maintained as a combination of orientation, location and destination. A guidance server provides a mapping from a user's current location to directions to a desired destination. Communication links maintain communication between the tactile direction device and the guidance server. The compass, tactile direction device, communication links and guidance server all interact to provide direction information to a user via a tactile surface. The tactile direction device is small enough to be hand-held or incorporated, . . . .”

8. U.S. Pat. No. 6,987,512 - - - (2006)
This application is entitled 3D navigation techniques.
   “A system and method is provided for facilitating navigation techniques in a three-dimensional virtual environment. The present invention couples input driving techniques to the state of one or more workspace variables (e.g., object state, virtual body state, environment state) to change the user's viewing context within a single input control motion. Modification of the user's viewing context allows navigation to various positions and orientations with out the need to be provided with that viewing context prior to navigation. The modification of the user's viewing context also allows for single input motion employing the same input drive controls.”

9. U.S. Pat. No. 6,838,998 - - - (2005)
This application is entitled Multi-user global position tracking system and method.
   “A system and method is provided for facilitating navigation techniques in a three-dimensional virtual environment. The present invention couples input driving techniques to the state of one or more workspace variables (e.g., object state, virtual body state, environment state) to change the user's viewing context within a single input control motion. Modification of the user's viewing context allows navigation to various positions and orientations with out the need to be provided with that viewing context prior to navigation. The modification of the user's viewing context also allows for single input motion employing the same input drive controls.”

10. U.S. Pat. No. 7,068,163 - - - (2006)
This application is entitled Method and apparatus for identifying waypoints using a handheld locator device.
   “A locator device includes a pocket-sized casing that contains a keyless remote entry circuit for remotely operating a vehicle security system. A GPS receiver circuit is located in the casing and automatically identifies a vehicle waypoint whenever the vehicle is turned off. The locator device then determines from any current location and with a single button press the direction and/or distance back to the vehicle waypoint. Many other novel applications are also performed by the locator device.”

11. U.S. Pat. No. 6,693,622 - - - (2004)
This application is entitled Vibrotactile haptic feedback devices.
   “Method and apparatus for controlling magnitude and frequency of vibrotactile sensations for haptic feedback devices. A haptic feedback device, such as a gamepad controller, mouse, remote control, etc., includes a housing grasped by the user, an actuator coupled to the housing, and a mass. In some embodiments, the mass can be oscillated by the actuator and a coupling between the actuator and the mass or between the mass and the housing has a compliance that can be varied. Varying the compliance allows vibrotactile sensations having different magnitudes for a given drive signal to be output to the user grasping the housing. In other embodiments, the actuator is a rotary actuator and the mass is an eccentric mass rotatable by the actuator about an axis of rotation. The eccentric mass has an eccentricity that can be varied relative to the axis of rotation while the mass is rotating. Varying the eccentricity allows vibrotactile sensations having different magnitudes for a given drive . . . .”

Our uniqueness in our invention is still evident over prior art that was not ever patented but related to our work. In addition, there have been many instances of applications in the past that have represented compass information as a belt or provided gps information or compass information as an orientation and or wayfinding aid for people who are blind [Nagel et al., 2005], [Rukzio et al., 2005], [Tsukada and Yasumura, 2004], [Goodman et al., 2005], [Bosman, 2003], [Erp, 2005]. What distinguishes our work is taking advantage of the saltation effect to provide a continuum as well as combining compass, gps information as input to provide landmark referencing and presenting this information via a haptic belt.

We are not the first to propose or develop a tactile belt or wearable technology that provides spatial information. As can be seen from the patents, none of the other patents fully integrated all the functionality and method of presentation that our tactile belt does. However, we are the first to present a viable technology that is affordable, wearable, portable, modular as well as incorporating a novel method for presenting tactile information that capitalizes on the unique abilities of how the human brain processes tactile information. Other relevant literature that was never patented includes the following:
Wendy Strobel, Jennifer Fossa, Carly Panchura, Katie Beaver, and Janelle Westbrook (2004). (University of Buffalo, Center for Assistive Technology, http:/cosmost.ot.buffalo.edu/T2RERC), The Industry Profile on Visual Impairment.
   A comprehensive profile on the visual impairment marketplace.
Roger Cholewiak, Angus Rupert. (2006). Tactile Situation Awareness System. http://www.namrl.navy.mil/TSAS/achievements.html, http://tactileresearch.org/rcholewi/TRLProjects.html, NAMRL (Naval Aerospace Medical Research Laboratory, Florida, USA).
   A vibrotactile vest was developed and tested on navy pilots during the years from the early 1990s to 2006. Up/down and target location was encoded by vibrating motors that the pilot wore. The US Navy loses 10 jets per year, chiefly due to spatial disorientation of the pilot. In 2003, this vest was tested by the NRC Aerospace Research (NRC IAR) and Defence R&D Canada (DRDC Toronto). The project was a success but the Navy stopped the project in 2006 due to cost over-runs.
Bob Cheung (2004), The Resurgence of Tactile Display Technologies, Aviation, Space & Environmental Medicine, vol. 75, No. 10, October, pp. 925-926,
   Position, motion cues during flight, communication amongst soldiers, orientation for vestibular patients or elderly, divers in undersea explorations, UAV (unmanned aerial vehicles), astronauts during extra-vehicular activities are just some of the applications where tactile displays can be used. The tactile channel isnt a replacement but a supplement to vision, when visual and auditory sensory channels are unavailable, disabled or overloaded in multi-environment applications. Tactile Sight has been in discussions with Dr. Cheung about developing tactile technology for spatial orientation for his research efforts.
Jan B. F. Van Erp, Hendrick A. H. C. Van Veen, Chris Jansen, Trevor Dobbins, (2005), Waypoint Navigation with a Vibrotactile Waist Belt, AMC Transactions on Applied Perception, Vol. 2, No. 2, April, pp. 106-117.
   This Dutch group is part of the TNO Human Factors in the Netherlands. They have tested the feasibility of presenting navigational information in a tactile display. The direction is based on location and was shown to be an effective coding. The encoding of distance via vibration rhythm was found to not improve performance. There were 2 studies using helicopter and fast boat navigation. A compass and GPS was used as input and the directional information was fixed to 8 motor locations, separated by 45 degrees. They have also studies a SUIT application for tactile orientation cuing for astronauts.
Koji Tsukada, Michiaki Yosumura, (2004), Active Belt: Belt-type wearable tactile display for directional information, Proc. Of UbiComp 2004, Springer LNCS3205, pp. 384-399.
   A belt was developed by this Japanese group using 8 motors and a geomagnetic sensor as well as a GPS. An user enters a destination GPS coordinate using an external interface. Distance was also encoded but no benefit was observed. Potential applications suggested include human navigation, location awareness information services, lost properties, entertainment. Appears to be an academic project that did not progress beyond this. http://mobiquitous.com/activebelt-e.htm
http://der-mo.net/feelspace
   An academic group from Norway that studied the long term stimulation with orientation via vibrotactile input. They hypothesized and showed that the individual was able to cognitively sense direction and perception of vibrations on the belt were not the dominant perception.
Ted Kruger (2004), Synthetic Senses, Leonardo, vol. 37, No. 4, pp. 322-323, MIT Press.
   A MIT researcher that used a tactile belt to investigate the tactile input of magnetic field perception in space experiments. He demonstrated that a magnetomer can sense large-scale magnetic fields surrounding electric motors of a commuter train and flux of current feeding them, thus concluding that magnetomers not only able to sense earths gravitional field but also human physical phenomenon.
http://ambafrance-ca.org/hyperlab/actualite/archive-us/us-commtactile.htm
   Research at the STAPS (Physical and Sports Activity), UFR (Training and Research dept) at the Caen University in France, investigating the development of a tactile compass for operational commandos on a military mission.
Martin Eimer, Bettina Forster, Jonas Vibell (2005), Cutaneous saltation with and across arms: a new measure of the saltation illusion in somatosensation, Perception & Psychophysics, 67(3), pp. 458-468.
   Strong evidence that saltation effect is really the primary somatosensory cortex ability to interpolate between tactile sensations.
Pamela J. Hopp-Levine, C. A. P. Smith, Benjamin A. Clegg, Eric D. Heggestad (2006), Tactile Interruption management: tactile cues as task switching reminders, Cogn. Techn. Work, 8: 137-145.
   Tactile cues are effective mans for simplifying work tasks associated with remembering.

### OBJECTS

### Summary of the Invention

Accordingly, several objects of our invention are:
Our wearable tactile navigation system overcomes the exponential challenges of haptic navigation. The system consists of a digital compass, accelerometer, BPS positioning unit, bluetooth communications module, memory card, integrated rechargeable battery system, USB connectivity for firmware and user data updates and an optional character display. The accelerometer is used to provide tilt compensation to the compass and identify environmental features by detecting features in the signal that signify the gait required to move around the obstacles. An additional feature is the possibility to include a camera system.
Our wearable tactile navigation system is solely reliant on the tactile modality for providing all navigational information to move around in our world.
Our wearable tactile navigation system has a unique method for providing a continuum of directional information capitalizing on the human tactile perceptual system. Other systems have only provided discrete location points, where the amount of information or points was dictated by the number of motors available. We only use 4 motors to provide 360 degrees of tactile information.
Our wearable tactile navigation system interfaces to the internet via a wireless channel that connects to a cell phone or PDA (Personal Digital Assistant). Our device can make use of our positional sensors such as GPS on the mobile device. Caretakers can also be notified of the position of their patients.
Our wearable tactile navigation system provides an affordable, wearable, portable solution for navigation for people who are blind or people who suffer from Alzheimer's.

Further objects and advantages of our invention will become apparent from a consideration of the drawings and ensuing description thereof.

### DRAWINGS

None of the figures depict inventions that have already been patented.

### DESCRIPTION OF THE DRAWINGS

The invention will now be described in more detail, by way of example only, with reference to the accompanying drawings, which are labeled FIGS. 1 through to 5 and included at the end of the application package, on pages 37 through to 41.

FIG. 1 illustrates one mode of operation of the controller. The controller fuses the sensor information to provide a geographical (in terms of longitude, latitude and altitude) absolute position and position relative to a pre-defined landmark. A distance motor encodes in tactile form, the distance to the landmark. If the direction to the landmark aligns with one of the cardinal directions, then only a single directional motor is activated.

FIG. 2 illustrates another mode of operation of the controller. The controller fuses the sensor information to provide a geographical (in terms of longitude, latitude and altitude) absolute position and position relative to a pre-defined landmark. A distance motor encodes in tactile form, the distance to the landmark. If the direction to the landmark falls between 2 cardinal directions, then those 2 cardinal motors are activated in such a fashion that the human user correctly interpolates and identifies the direction at the analogous (to the real world) position between those 2 cardinal directions.

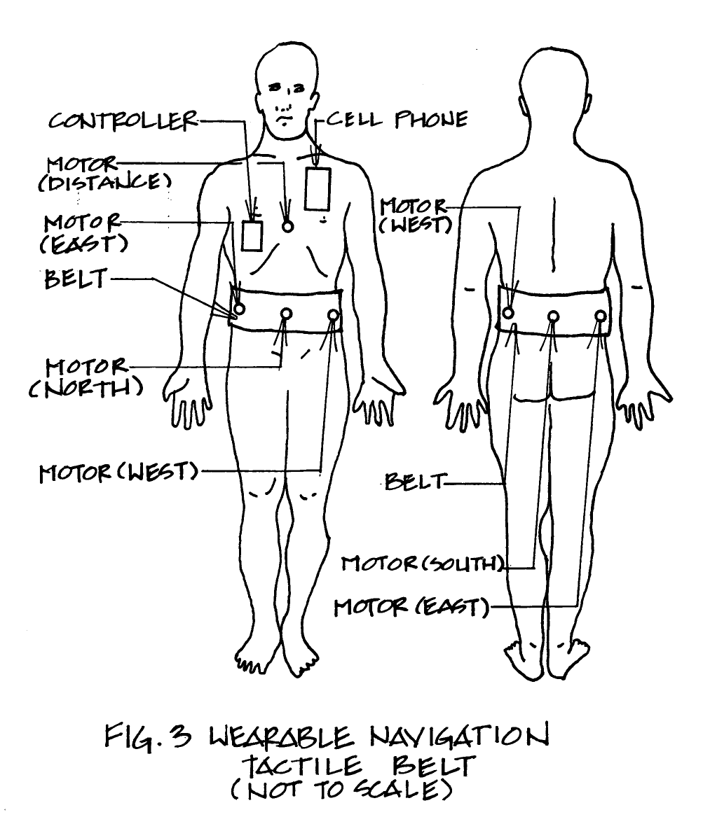

FIG. 3 illustrates one embodiment of the wearable tactile navigation system. A belt contains the 3 directional motors at the cardinal locations. The controller can be embedded on the belt or disengaged as shown on the chest. The distance motor is placed somewhere else on the body so that it does not align with the directional motors (shown on the chest). The user's cell phone (shown on arm) wirelessly communicates with the system controller.

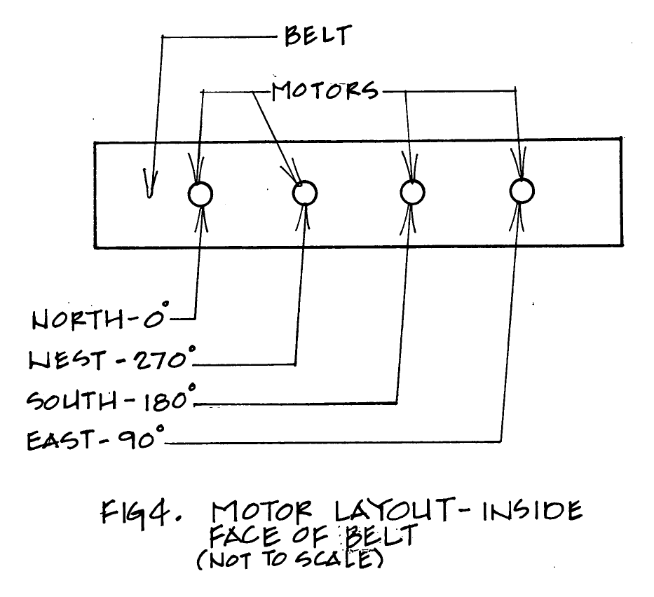

FIG. 4 illustrates the motor alignment on the belt when it is laid flat. It is assumed that the left and right sides connect when worn to form a circle. The diagram can also be interpreted as conceptual where the belt is a general band that can be worn on the writs, head, chest to name a few but incomplete placements on the human body of the user.

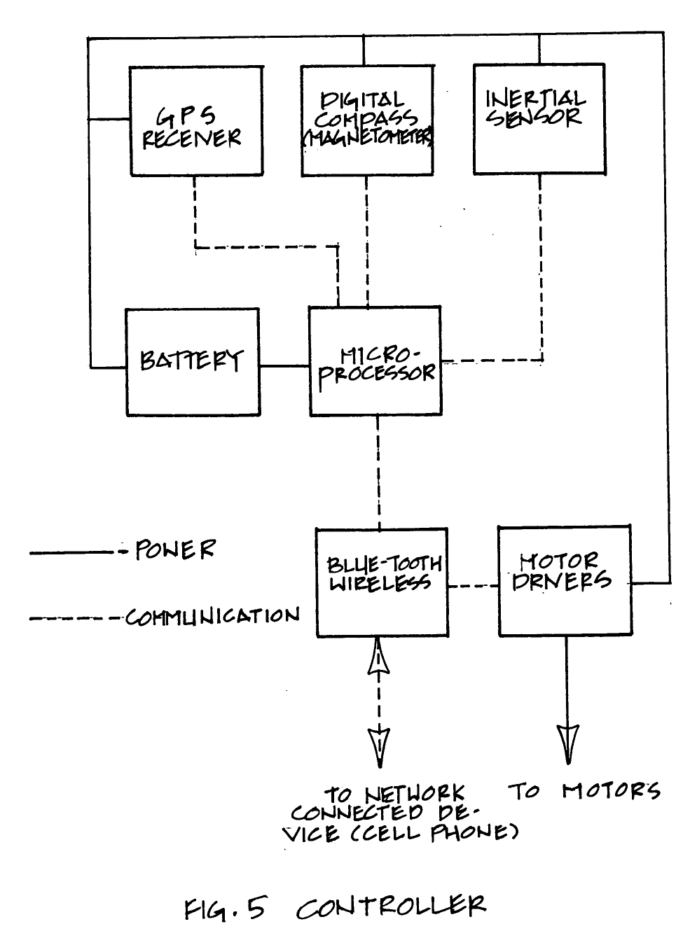

FIG. 5 is a detailed conceptual drawing of the controller. The internal battery supplies power to the GPS receiver, digital compass, inertial sensor microprocessor, bluetooth wireless interface and motor drivers. The sensors (GPS, compass, inertial) provide geographical information to the microprocessor which decides what motor(s) to activate and how to activate them.

The figures are described in the previous text.

While the patent invention shall now be described with reference to the preferred embodiments shown in the drawings, it should be understood that the intention is not to limit the invention only to the particular embodiments shown but rather to cover all alterations, modifications and equivalent arrangements possible within the scope of appended claims.

### DESCRIPTION

Our wearable tactile navigation system is (and has been demonstrated to be) a functioning and affordable proof of concept prototype of a wearable device that allows you to navigate using only touch. The device frees you from requiring to use your eyes as there is no display, all information is conveyed via touch. As a compass, the device nudges you towards North. As a GPS navigator, the device orients you towards a landmark (i.e., home) and lets you feel how far away home is. A bluetooth interface provides network capabilities, allowing you to download map landmarks from a cell phone. The bidirectional networking capability generalizes the device to a platform capable of collecting any sensor data as well as providing tactile messages and touch telepresence.

Our innovative method of providing tactile spatial information capitalizes on how the human tactile perception system interpolates sensations to provide detail information. Our innovative engineering design integrates a GPS, 3-axis compass and inertial sensor, power management, battery and embedded processor (for executing our realtime intelligent perception and control algorithms) in a compact and cost-effective package. We plan on capitalize on new technology, for example, new GPS receivers are highly sensitive and can provide positional information to users indoors.

The original application was a way-finding device for the blind. Approx. 4 million (M) Americans have a severe visual impairment (VI) and 8.3 M have some VI. Another Assistive Technology (AT) market is dementia which is estimated at 18 M world-wide. Other markets include the military, tourist, hiker, and search and rescue.

### Operation

The physical components of the system include the following:
4 vibro-tactile (haptic, tactile, pager) motors that provide directional information;
1 distal vibro-tactile motor that provides distance information;
a controller consisting of:
   1. power management system,
   2. battery,
   3. GPS receiver,
   4. 3-axis accelerometer,
   5. digital compass (magnetometer),
   6. bluetooth transmitter/receiver, and
   7. possibly the inclusion of vision (camera) system in the future.
a material (e.g., neoprene) for the wearable medium that the motors embed on before being worn by the user, so that the vibration and forces exerted by the motor(s) are vertically conducted to the skin and there is minimal lateral conduction of the energy.

Via the bluetooth wireless interface, the system receives a single or a collection of landmarks that are to be used as the current landmark and to be processed in the order provided. Once the person is in the vicinity of the current landmark, the landmark information is removed from the queue to be processed and the next one is labeled as the current landmark.

### OTHER EMBODIMENTS

While the above description contains many specificities, these should not be construed as limitations on the scope of the invention, but rather as an exemplification of one preferred embodiment thereof. Many other variations are possible, for example:
The device can take other forms than a belt.
The only constraint is that a continuum of orientations is possible, for example, around the arm, thigh, neck, head.
The device's size is only limited by the electronics.
Communication can be RF, bluetooth, infrared.
The maps and database that the system might reference are best off loaded to another device such as a cell phone of i-pod.

Accordingly, the scope of the invention should be determined not by the embodiment illustrated, but by the appended claims and their legal equivalents.

### CROSS REFERENCE TO DISCLOSURE DOCUMENT

The application was originally submitted as a provisional patent on Feb. 16, 2006.

The embodiments of the invention in which I claim an exclusive property or privilege are defined as follows:

1. A tactile feedback navigation system comprising:
means for detecting the global orientation of the user;
means for detecting geographic co-ordinate position (in terms of latitude and longitude) of the user;
means for detecting 3-directional accelerations of the user;
exactly four tactile actuators, that will provide directional information to a landmark and its inherent coordinate system, placed in the cardinal locations (North (N), South (S), West (W), and East (E)) aligned on a body part (e.g., waist) upon which we can superimpose a scale system (that defines a circle) that repeats itself from 0 to 359 degrees, i.e., 360 degrees is equivalent to 0 degrees; and each cardinal location is exactly separated by 90 degrees;
at least one tactile actuator that provides distal information to a landmark;
a wireless communication method to communicate to an internet network via an external device (e.g., computer, cell phone);
an integrated power management and portable power source; and
a controller that fuses all the on-board and off-board sensors into an optimal accurate estimate of global position in terms of latitude and longitude and possibly attitude and if the sensors provide, the position and size of objects and terrain in the immediate environment.

2. A tactile feedback navigation system as claimed in claim 1, wherein the entire system is a portable unit and worn by the user.

3. A tactile feedback navigation system as claimed in claim 1, wherein the entire system is a system that the user makes direct physical contact with.

4. A tactile feedback navigation system as claimed in claim 1, that acts as a tactile compass where no visual attention or its use is required by the user and information is purely provided in tactile form.

5. A tactile feedback navigation system as claimed in claim 1, that acts as a GPS (Global Positioning System) where direction to a waypoint is purely provided in tactile form and no use of the visual sense is required by the user.

6. A tactile feedback navigation system as claimed in claim 1, wherein the controller can be separated into 2 separated components, where one component fuses the positional information that the sensors provide and produces the signal for the actuation of the tactile units and the other component generates the tactile unit(s) actuation signals.

7. A tactile feedback navigation system as claimed in claim 1, wherein the wireless link can be used to provide a single or procedural sequence of waypoints; the wireless link can be used to provide additional sensor information (GPS, digital compass) from the external device (e.g., cell phone, pda, computer) that connects to the internet network; the wireless link can provide GIS (Geographic Information System) map information that can provide landmarks, obstacles or terrain characteristics; and the wireless link is used to provide positional information about the user to a remote monitor or caretaker.

8. A tactile feedback navigation system as claimed in claim 1, wherein 4 tactile actuators placed at cardinal locations providing directional information are attached to the body by a piece of clothing that hugs around a body part. The clothing should have the property that it readily transmits the tactile stimuli into the skin and minimizes lateral transmission along the piece of clothing. A material that does this is neoprene but the claim is not limited to neoprene.

9. A tactile feedback navigation system as claimed in claim 8, wherein the tactile actuating piece of clothing is a belt; wrist band; arm band; head band; leg band; and chest belt.

10. A tactile feedback navigation system as claimed in claim 8, wherein an additional tactile motor not aligned or in close proximity to the 4 directional tactile actuators is used to provide distal information to the user. The strength of method of stimulating the actuator can be inversely correlated with the distance to the landmark/target. The strength of method of stimulating the actuator can also be proportionally correlated with the distance to the landmark/target.

11. A tactile feedback navigation system as claimed in claim 5, wherein a queue of waypoints is provided to the controller in order to guide the user in tactile form to a final destination via the intermediate waypoints. An annunciation method can be provided to the user to indicate that the current intermediate waypoint has been reached and a new waypoint is the new current intermediate waypoint. The method of annunciation can either be tactile, auditory or visual. Another annunciation method can be provided to the user to indicate that the final goal destination has been reached. The method of annunciation can either be tactile, auditory or visual.

12. A tactile feedback navigation system as claimed in claim 8, wherein if the actual direction indicated by the directional device is aligned with any of the cardinal directions (N, S, W, E) indicated by 0 to 360 degrees and being a multiple of 90, only a single motor corresponding to that cardinal direction is activated and the other 3 directional motors are not activated. 0 degrees is defined as a geographical location which defines a coordinate frame of reference, for example if the modality is of a tactile compass, 0 would define magnetic North. If the desired direction falls between 2 cardinal directions, then the 2 actuators associated with cardinal directions that are closest to that direction are activated in such a fashion that the human body interprets this information as falling between the 2 cardinal positions at an orientation that corresponds to the direction the desired geographical location. The geographical location defining the coordinate frame of reference can be the Earth's magnetic North pole. The geographical location defining the coordinate frame of reference can also be a GPS defined waypoint, also referred to as the home or intermediate home position.

13. A tactile feedback navigation system as claimed in claim 12, wherein the actuator's intensity of vibration or mechanical force (i.e., amplitude) is the variable controlled; the actuator's frequency of vibration is the variable controlled; the actuator's waveform is the variable controlled; the actuator's pattern of activation is the variable controlled; the actuator's duration of activation is the variable controlled; the actuator's inter-stimulus interval is the variable controlled; or the actuator's inter-activity is the variable controlled.

14. A tactile feedback navigation system as claimed in claim 25, where the method of human tactile perceptual interpolation ability is based on the rabbit effect or also referred to as the cutaneous saltation effect.

15. A tactile feedback navigation system as claimed in claim 1, wherein the 1 or more tactile actuator providing distal information is related to the actuator(s)' intensity of vibration or mechanical force (i.e., amplitude) as the variable controlled; the actuator(s)' frequency of vibration as the variable controlled; the actuator(s)' waveform as the variable controlled; the actuator(s)' pattern of activation as the variable controlled; the actuator(s)' duration of activation as the variable controlled; the actuator(s)' inter-stimulus interval as the variable controlled; or the actuator(s)' inter-activity as the variable controlled.

16. A tactile feedback navigation system as claimed in claim 1, wherein the application of interest is wayfinding for people who are blind; or the application of interest is a homing device or localization device for people with Alzheimer's disease or dementia in general. The system can also be used as a tool for tracking of the patient by a caretaker or care facility.

17. A tactile feedback navigation system as claimed in claim 1, wherein the function of the entire system is to guide the user to landmarks/targets which may be organized as a sequence in queue.

18. A tactile feedback navigation system as claimed in claim 1, wherein the entire system can function as an obstacle avoidance system, a different mode than the general mode of being directed to a goal.

19. A tactile feedback navigation system as claimed in claim 1, wherein the entire system can function as a system that can guide the user in a preferred path, or trajectory, whether it be to avoid obstacles as in claim 43 or to maintain a straight line or follow a safe route to avoid injury.
